(19) United States
(12) Patent Application Publication
(10) Pub. No.: US 2026/0292295 A1
(43) Pub. Date: Sep. 24, 2026

(54) REMOTE VIDEO STREAM FRAME PROCESSING

(71) Applicant: Hewlett-Packard Development Company, L.P., Spring, TX (US)

(72) Inventor: Kenneth J. Savage, Vancouver (CA)

(73) Assignee: Hewlett-Packard Development Company, L.P., Spring, TX (US)

(21) Appl. No.: 19/484,335

(22) PCT Filed: May 19, 2023
(86) PCT No.: PCT/US2023/022958

§ 371 Date: Nov. 13, 2025

(51) Int. Cl. H04N 21/439; H04N 21/462

(52) U.S. Cl. CPC H04N 21/4392; H04N 21/462

(57) ABSTRACT

A method to process a video stream, comprising: decoding a video stream into a plurality of frames, each frame comprising video information and a timestamp; storing the frames in a buffer, determining a display frame rate associated with a video display, determining a future display time value from the display frame rate and a current time, processing a first frame of the plurality of frames based upon the future display time value, a timestamp associated with the first frame, and timestamps of additional frames stored in the buffer, wherein processing comprises one of: (a) sending the first frame to the video display and removing the first frame from the buffer, (b) refraining from sending the first frame to the video display and refraining from removing the first frame from the buffer, or (c) refraining from sending the first frame to the video display and removing the first frame from the buffer.

### BACKGROUND

Videos and other multimedia content are often streamed between a host and client device(s) in a remote desktop environment. Given two independent devices without electronic interlocking, potentially asymmetric polling intervals, refresh rates, clock skew/drift, phase differences, compression latency and network queuing, a desynchronization is likely between the host side's capture and the client side's presentation of remoted frames of a video stream. Under these conditions, video content containing smooth motion or other gentle panning actions, for example, may appear stuttered on the client side. It would be helpful for a system to analyze video stream frame metadata and make a decision as to whether send or drop an incoming frame from a host device to minimize inter-frame presentation jitter on the client side.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a block diagram illustrating an example remote video stream processing system for providing a video stream to a display;

FIG. 2 is a block diagram illustrating an example client device in a remote video stream processing system;

FIG. 3 illustrates an example frame processing analysis performed by a client device;

FIG. 4 is a flow diagram depicting an example routine for processing a video stream;

FIG. 5 is a flow diagram depicting an additional example routine for processing a video stream by sending a frame of the stream to a display; and

FIG. 6 is a flow diagram depicting an additional example routine for processing a video stream by refraining from sending a frame of the stream to a display.

### DETAILED DESCRIPTION

A remote video stream processing system may be configured to provide smooth and accurately reproduced content playback on the client side of a remoted desktop environment. In a common application, the system may assign timestamps to frames of an incoming video stream stored in a buffer. The system may further determine, on a frame-by-frame basis, whether to send a frame of the video stream to a client-side display, based on the timestamps of buffered frames and potential error between the host's streamed content and the displayed playback.

Aspects of the present disclosure relate to a method to process a video stream, comprising: decoding a video stream into a plurality of frames, each frame comprising video information and a timestamp; storing the plurality of frames in a buffer; determining a display frame rate associated with a video display; determining a future display time value from the display frame rate and a current time; processing a first frame of the plurality of frames based upon the future display time value, a timestamp associated with the first frame, and timestamps of additional frames stored in the buffer; wherein said processing comprises one of: (a) sending the first frame to the video display and removing the first frame from the buffer, (b) refraining from sending the first frame to the video display and refraining from removing the first frame from the buffer, or (c) refraining from sending the first frame to the video display and removing the first frame from the buffer.

In some aspects, the techniques described herein relate to a method to process a video stream, wherein the audio stream is uncompressed.

In some aspects, the techniques described herein relate to a method to process a video stream, wherein the additional frames stored in the buffer comprises all of the frames stored in the buffer except for the first frame.

In some aspects, the techniques described herein relate to a method to process a video stream, further comprising receiving an indication of a number of frames to include as the additional frames stored in the buffer.

In some aspects, the techniques described herein relate to a method to process a video stream, further comprising receiving a latency tolerance value and wherein said processing the first frame of the plurality of frames is further based on the latency tolerance value.

In some aspects, the techniques described herein relate to a method to process a video stream, further comprising determining error values associated with displaying the first frame and not displaying the first frame, and wherein said processing is further based upon said error values.

In some aspects, the techniques described herein relate to a method to process a video stream, wherein said error value corresponds to latency values associated with a next frame to be displayed.

In some aspects, the techniques described herein relate to a method to process a video stream, wherein said processing comprises refraining from sending the first frame to the video display and removing the first frame from the buffer when the timestamp associated with the first frame is earlier than the display time.

In some aspects, the techniques described herein relate to a method to process a video stream, wherein said processing comprises sending the first frame to the video display and removing the first frame from the buffer when the timestamp of the first frame exceeds the display time by less than an acceptable latency value.

In some aspects, the techniques described herein relate to a method to process a video stream, wherein the acceptable latency value is 150 ms.

Aspects of the present disclosure relate to a method to process a video stream, comprising: storing a plurality of frames of a video stream in a buffer, each frame comprising video information and a timestamp; determining a display frame rate associated with a video display; determining a future display time value from the display frame rate and a current time; and processing a first frame of the plurality of frames based upon the future display time value, a timestamp associated with the first frame, and timestamps of additional frames stored in the buffer, wherein processing comprises sending the first frame to the video display and removing the first frame from the buffer when the timestamp of the first frame exceeds the display time by less than an acceptable latency value.

In some aspects, the techniques described herein relate to a method to process a video stream, wherein the additional frames stored in the buffer comprises all of the frames stored in the buffer except for the first frame.

In some aspects, the techniques described herein relate to a method to process a video stream, further comprising receiving an indication of a number of frames to include as the additional frames stored in the buffer.

In some aspects, the techniques described herein relate to a method to process a video stream, further comprising receiving a latency tolerance value and wherein said processing the first frame of the plurality of frames is further based on the latency tolerance value.

In some aspects, the techniques described herein relate to a method to process a video stream, further comprising determining error values associated with displaying the first frame and not displaying the first frame, and wherein said processing is further based upon said error values.

In some aspects, the techniques described herein relate to a method to process a video stream, wherein said error value corresponds to latency values associated with a next frame to be displayed.

Aspects of the present disclosure relate to a method to process a video stream, comprising: storing a plurality of frames of a video stream in a buffer, each frame comprising video information and a timestamp; determining a display frame rate associated with a video display; determining a future display time value from the display frame rate and a current time; processing a first frame of the plurality of frames based upon the future display time value, a timestamp associated with the first frame, and timestamps of additional frames stored in the buffer; wherein said processing comprises refraining from sending the first frame to the video display and removing the first frame from the buffer when the timestamp associated with the first frame is earlier than the display time.

In some aspects, the techniques described herein relate to a method to process a video stream, wherein the additional frames stored in the buffer comprises all of the frames stored in the buffer except for the first frame.

In some aspects, the techniques described herein relate to a method to process a video stream, further comprising receiving an indication of a number of frames to include as the additional frames stored in the buffer.

In some aspects, the techniques described herein relate to a method to process a video stream, further comprising receiving a latency tolerance value and wherein said processing the first frame of the plurality of frames is further based on the latency tolerance value.

In some aspects, the techniques described herein relate to a method to process a video stream, further comprising determining error values associated with displaying the first frame and not displaying the first frame, and wherein said processing is further based upon said error values, wherein said error value corresponds to latency values associated with a next frame to be displayed.

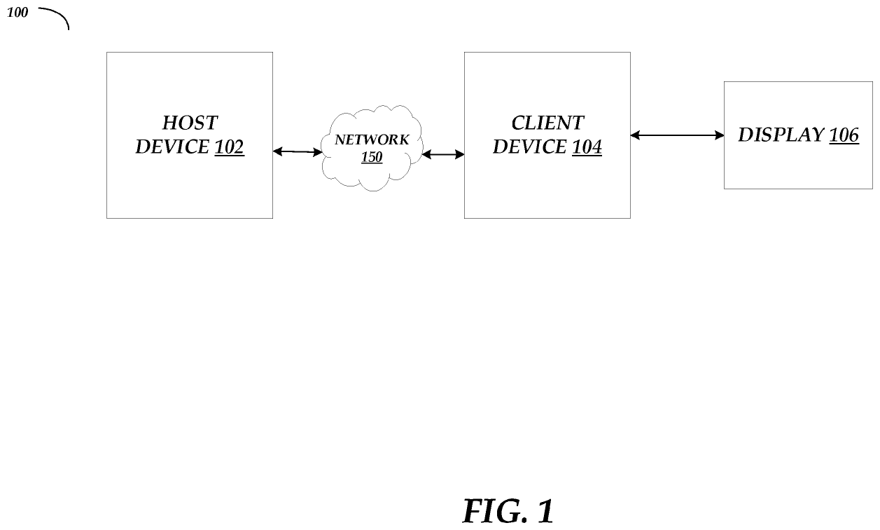

FIG. 1 illustrates an example of a remote video stream processing system 100 for providing a video stream to a display. Remote video stream processing system 100 includes host device 102, client device 104, and display 106.

As illustrated in FIG. 1, host device 102 may be any device capable of sending a video stream. Host device 102 may include personal computing devices, laptop computing devices, tablet computing devices, electronic reader devices, wearable computing devices, mobile devices (e.g., cellular and other mobile phones, smart phones, media players, handheld gaming devices, etc.), streaming media devices, and various other electronic devices and appliances. In some examples, host device 102 may be a virtual machine. Host device 102 may be communicatively coupled to client device 104. For example, host device 102 and client device 104 may be connected via network 150, wireless communication such as BLUETOOTH®, Wi-Fi®, according to an IEEE 802 standard, etc.

Client device 104 may be any device capable of receiving and sending a video stream to a display. Client device 104 may include personal computing devices, laptop computing devices, tablet computing devices, electronic reader devices, wearable computing devices, mobile devices (e.g., cellular and other mobile phones, smart phones, media players, handheld gaming devices, etc.), streaming media devices, and various other electronic devices and appliances. In some examples, client device 104 may be configured to receive a video stream content from the host device 102 in the form of video information (e.g., frames) and timestamps. In some examples, client device 104 may make a determination whether to send or drop specific frames of the video stream to the display 106.

Display 106 may be any device capable of displaying a video stream. As illustrated, display 106 may be physically connected to client device 104. For example, display device 106 may be connected to client device 104 using a wired connection. In some examples, display 106 may be integrated within the hardware of client device 104 and refer to a screen of the client device 104. In some examples, due to the physical connection between the client device 104 and the display 106, both devices may be electronically synchronized.

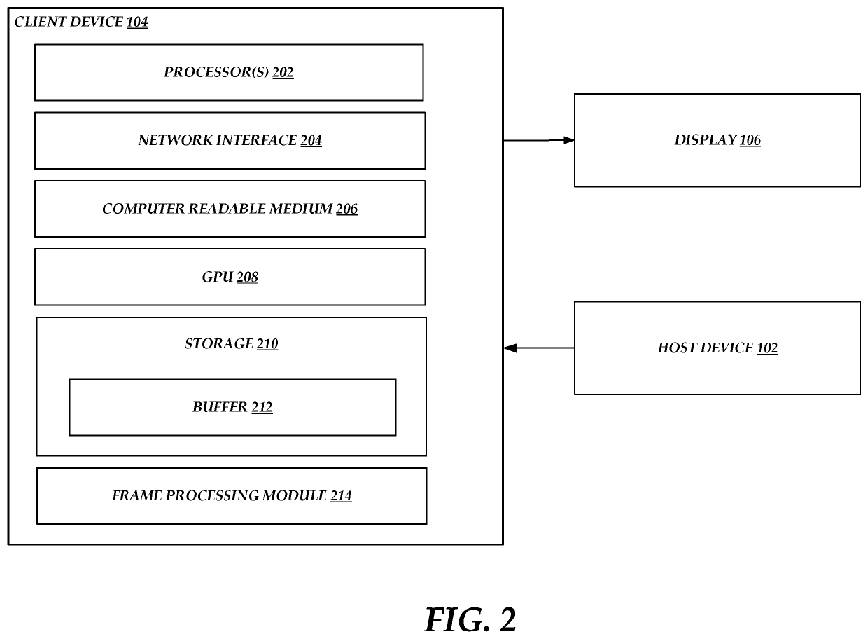

FIG. 2 is a block diagram illustrating an example client device 104 in a remote video stream processing system 100. As shown, client device 104 may be communicatively coupled to host device 102 and display 106. In an example, host device 102 may send a video stream to the client device 104 to be displayed on display 106. Each component of client device 104 will be described in turn.

As illustrated in FIG. 2, client device 104 includes processor(s) 202; network interface 204, such as a network interface card (“NIC”); computer readable medium 206, such a high density disk (“HDD”), solid state drive (“SDD”), flash drives, and/or other persistent non-transitory computer-readable media; graphics processing unit (“GPU”) 208, storage 210, such as random access memory (“RAM”) and/or other volatile non-transitory computer-readable media; buffer 212, and frame processing module 214.

Client device 104 includes processor(s) 202, such as a physical central processing unit (“CPU”), etc. Processor(s) 202 may decode the video stream as it is being received from the host device 102. For example, processor(s) 202 may decode the video stream into a plurality of frames (e.g., video information and a corresponding timestamp).

In some examples, processor(s) 202 will determine a timestamp for each decoded frame of the video stream. In some examples, the timestamps for each frame are of high granularity such that a frame rate of the display 106 may be resolved. In some examples, if the timestamps from the host device 102 are not available, the processor(s) 202 may examine the video stream at a packet level and estimate the timestamps between successively transmitted frames from the host device 102. In some examples, time deltas between successive frames of a decoded video stream may correspond to the time deltas of the original streamed video on the host side.

In some examples, processor(s) 202 may be connected to other components within client device 104. For example, processor(s) 202 may send decoded frames of a video stream to buffer 212.

Buffer 212 may be an area within memory 210 that is configured to store frames of the video stream and may include both the video information and the corresponding timestamp of each frame. In some examples, buffer 212 may store any number of frames at a time. For example, buffer 212 may store 1, 2, 5, 10 . . . N frames at a time. In some examples, the amount of frames stored by buffer 212 at a time may depend on the speed at which processor(s) 202 receives and decodes the video stream, which may further depend on network conditions, connectivity conditions etc. between the host device 102 and client device 104.

GPU 208 may include a graphics processing core with specialized circuitry and logic to process image/video and/or other digital signal-based data. In some examples, GPU 208 is located within client device 104. In some examples, GPU 208 is located within the display 106 and is in communication with client device 104. In some examples in which the display 106 is integrated within client device 104, the GPU 208 is located within client device 104. In some examples, GPU 208 may manage the retrieval and display of the frames according to a frame rate associated with the display 106. The frame rate, as understood in the field, corresponds to the frequency or rate at which consecutive images, or frames, are displayed (e.g., frames per second).

Frame processing module 214 may communicate with components of the client device 104 in order to determine whether certain frames of the video stream will be sent to the display 106. In some examples, frame processing module 214 may be implemented as software. In some examples, given a number of frames in the buffer 212, the frame processing module 214 may make a determination as to whether to send a first buffered frame to the display 106 based on timestamps of all buffered frames and a future display time value. In some examples, the future display time value corresponds to the frame rate of display 106 and a current time.

In some examples, the frame processing module 214 will make a determination as to whether to send a frame to the display 106 in order to minimize inter-frame presentation jitter. For example, upon a display refresh event (as determined by the GPU's frame rate of the display) occurs, the frame processing module 214 will either push a frame to the display, wait to push the frame, or drop the frame. In some examples, the frame processing module 214 will make a decision in order to minimize timing error, i.e., to minimize latency.

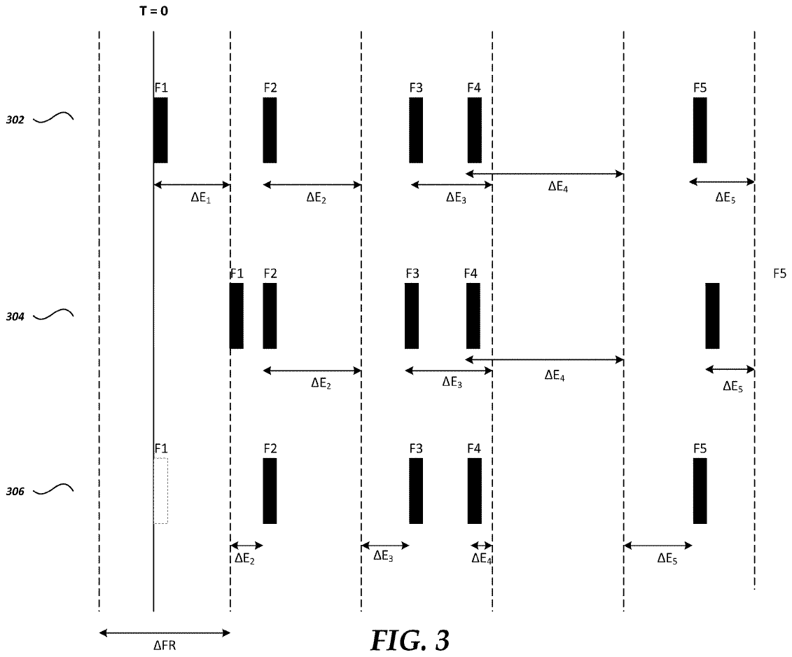

FIG. 3 illustrates the frame processing analysis performed by the frame processing module 214. FIG. 3 illustrates the frame rate of display 106, shown by the dotted vertical lines, equally spaced apart by ΔFR. FIG. 3 also illustrates buffer 212 that may contain a plurality of frames, as shown by frames F1, F2, F3, F4, and F5. In some examples, buffer 212 may contain more or less frames. In an example, frames F1-F5 may be all the frames stored in buffer 212 at current time T=0.

In some examples, frame processing module 214 may decide, at T=0, whether to send, hold, or drop a first frame F1. This decision may be illustrated by a send scenario 302, a hold scenario 304, and a drop scenario 306. In some examples, the decision on how to handle F1 may be based on the total buffered frames F1-F5. For example, the analysis performed by frame processing module 214 may include calculating a total absolute error associated with the potential scenario. As used herein, absolute error may refer to the time between a buffered frame and a refresh cycle of the display frame rate, as shown by ΔE. As used herein, total absolute error may refer to the sum of ΔE for a scenario.

In some examples, in calculating the absolute error, frame processing module 214 may pair each buffered frame to a future display refresh cycle. It is noted that “future” may refer to a time greater than T=0. In some examples, frame processing module 214 may calculate ΔE between each frame and its corresponding refresh cycle. In some examples, frame processing module 214 may pair a single frame to a single future display refresh cycle.

For example, in a send scenario 302, frame processing module 214 may calculate the error if a first frame F1 is sent to the display at current time T=0. In this example, ΔE₁ may refer to the error between an F1 timestamp and a future refresh cycle. Similarly, ΔE₂-ΔE₅ may refer to the error between the F2-F5 timestamps and a paired future refresh cycle. The total absolute error associated with send scenario 302 may be represented by the sum of ΔE.

In a hold scenario 304, frame processing module 214 may calculate the total error if a first frame F1 is held until the upcoming display refresh cycle. In this example, F1 is sent to the display at a future display refresh cycle and the ΔE₁ is 0. However, ΔE₂-ΔE₅ may refer to the error between the F2-F5 timestamps and a paired future refresh cycle. The total absolute error associated with send scenario 302 may be represented by the sum of ΔE.

In a drop scenario 406, the frame processing module 214 may dropping the first frame, such as by not sending to the display and removing from the buffer. In this example, F1 is removed from the buffer. In this example, ΔE₂-ΔE₅ may refer to the error between the F2-F5 timestamps and a paired future refresh cycle. The total absolute error associated with send scenario 302 may be represented by the sum of ΔE.

In an example, frame processing module 214 may decide to execute a scenario with the lowest absolute error.

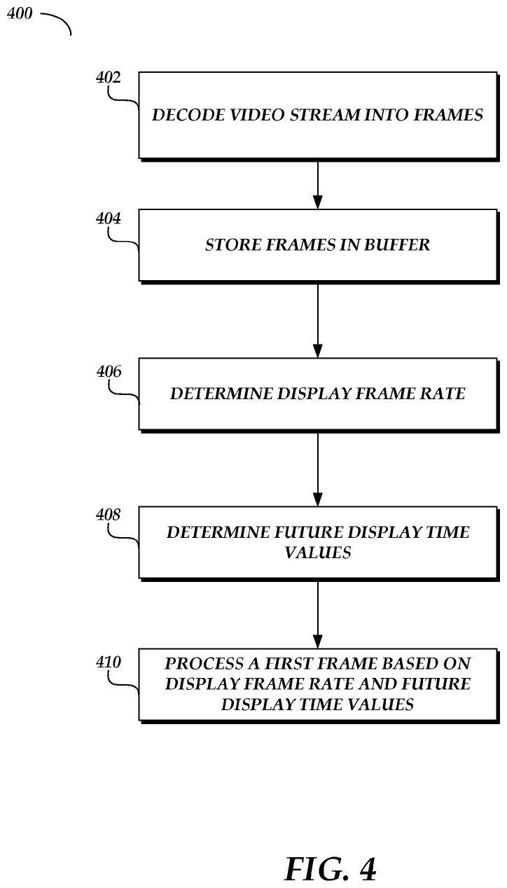

FIG. 4 is a flow diagram depicting an example routine 400 for processing a video stream. Routine 400 may be implemented by client device 104 within remote video stream processing system 100.

At block 402, client device 104 decodes a video stream into frames. In an example, client device 104 decodes the video stream into a plurality of frames. In an example, each frame comprises video information and a timestamp.

At block 404, client device 104 stores the frames in a buffer. In an example, client device 104 stores the plurality of frames in the buffer. In an example, additional frames stored in the buffer comprises all of the frames stored in the buffer except for a first frame. In an example, client device 104 may receive an indication of a number of frames to include as the additional frames stored in the buffer.

At block 406, client device 104 determines a display frame rate. In an example, client device 104 determines a display frame rate associated with a video display.

At block 408, client device 104 determines a future display time value. In an example, client device 104 determines a future display time value from the display frame rate and a current time.

At block 410, client device 104 processes a first frame based on the display frame rate and the future display time value. In an example, client device 104 processes a first frame of the plurality of frames based upon the future display time value, a timestamp associated with the first frame, and timestamps of additional frames stored in the buffer. In an example, processing comprises one of: (a) sending the first frame to the video display and removing the first frame from the buffer, (b) refraining from sending the first frame to the video display and refraining from removing the first frame from the buffer, or (c) refraining from sending the first frame to the video display and removing the first frame from the buffer.

In an example, client device 104 receives a latency tolerance value and wherein said processing the first frame of the plurality of frames is further based on the latency tolerance value.

In an example, client device 104 determines error values associated with displaying the first frame and not displaying the first frame, and wherein said processing is further based upon said error values. In an example, the error value corresponds to latency values associated with a next frame to be displayed.

In an example, processing comprises refraining from sending the first frame to the video display and removing the first frame from the buffer when the timestamp associated with the first frame is earlier than the display time.

In an example, processing comprises sending the first frame to the video display and removing the first frame from the buffer when the timestamp of the first frame exceeds the display time by less than an acceptable latency value. In an example, the acceptable latency value is 150 ms.

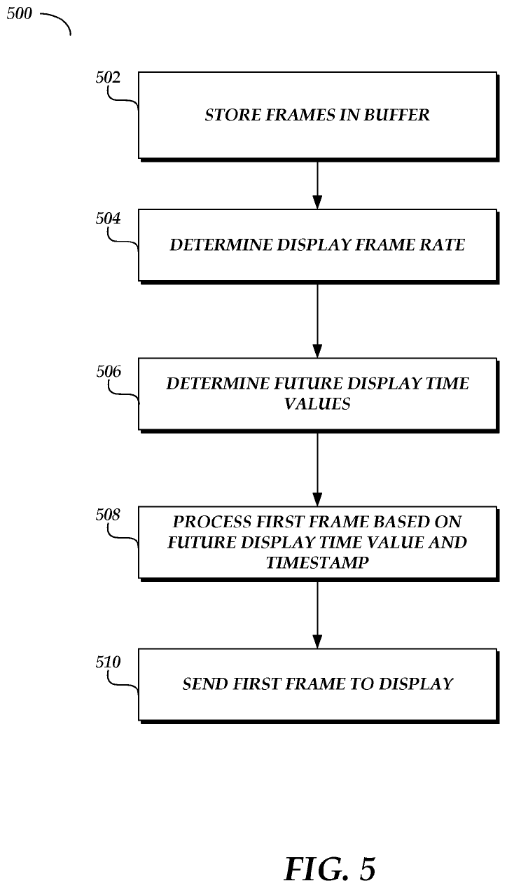

FIG. 5 is a flow diagram depicting an example routine 500 for processing a video stream by sending a frame of the stream to a display. Routine 500 may be implemented by client device 104 within remote video stream processing system 100.

At block 502, client device 104 stores frames in a buffer. In an example, client device 104 stores a plurality of frames of a video stream in a buffer. In an example, each frame comprises video information and a timestamp. In an example, additional frames stored in the buffer comprises all of the frames stored in the buffer except for a first frame. In an example, client device 104 receives an indication of a number of frames to include as the additional frames stored in the buffer.

At block 504, client device 104 determines a display frame rate. In an example, client device 104 determines a display frame rate associated with a video display.

At block 506, client device 104 determines a future display time value. In an example, client device 104 determines a future display time value from the display frame rate and a current time.

At block 508, client device 104 processes a first frame based on a future display time value and a timestamp. In an example, client device 104 processes a first frame of the plurality of frames based upon the future display time value, a timestamp associated with the first frame, and timestamps of additional frames stored in the buffer.

In an example, client device receives a latency tolerance value and wherein said processing the first frame of the plurality of frames is further based on the latency tolerance value.

In an example, client device 104 determines error values associated with displaying the first frame and not displaying the first frame, and wherein said processing is further based upon said error values. In an example, error value corresponds to latency values associated with a next frame to be displayed.

At block 510, client device 104 sends the first frame to a display. In an example, client device 104 removes the first frame from the buffer when the timestamp of the first frame exceeds the display time by less than an acceptable latency value.

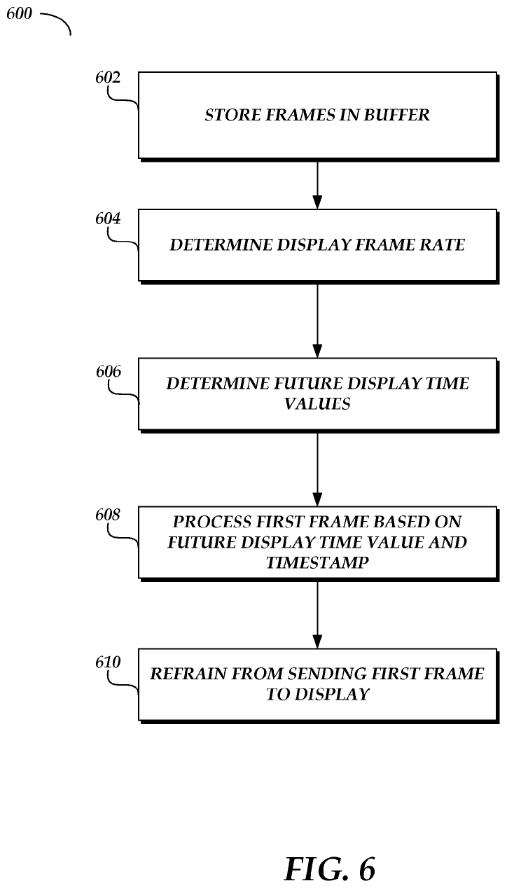

FIG. 6 is a flow diagram depicting an example routine 600 for processing a video stream by refraining from sending a frame of the stream to a display. Routine 600 may be implemented by client device 104 within remote video stream processing system 100.

At block 602, client device 104 stores frames in a buffer. In an example, client device 104 stores a plurality of frames of a video stream in a buffer. In an example, each frame comprising video information and a timestamp.

At block 604, client device 104 determines a display frame rate. In an example, client device 104 determines a display frame rate associated with a video display.

At block 606, client device 104 determines a future display time value. In an example, client device 104 determines the future display time value from the display frame rate and a current time.

At block 608, client device 104 processes a first frame based on a future display time value and a timestamp. In an example, client device 104 processes a first frame of the plurality of frames based upon the future display time value, a timestamp associated with the first frame, and timestamps of additional frames stored in the buffer.

At block 610, client device 104 refrains from sending the first frame to the display. In an example, client device 104 removes the first frame from the buffer when the timestamp associated with the first frame is earlier than the display time.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIG. s should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A method to process a video stream, comprising:
decoding a video stream into a plurality of frames, each frame comprising video information and a timestamp;
storing the plurality of frames in a buffer;
determining a display frame rate associated with a video display;
determining a future display time value from the display frame rate and a current time;
processing a first frame of the plurality of frames based upon the future display time value, a timestamp associated with the first frame, and timestamps of additional frames stored in the buffer;
wherein said processing comprises one of: (a) sending the first frame to the video display and removing the first frame from the buffer, (b) refraining from sending the first frame to the video display and refraining from removing the first frame from the buffer, or (c) refraining from sending the first frame to the video display and removing the first frame from the buffer.

2. The method of claim 1, wherein the additional frames stored in the buffer comprises all of the frames stored in the buffer except for the first frame.

3. The method of claim 1, further comprising receiving an indication of a number of frames to include as the additional frames stored in the buffer.

4. The method of claim 1, further comprising receiving a latency tolerance value and wherein said processing the first frame of the plurality of frames is further based on the latency tolerance value.

5. The method of claim 1, further comprising determining error values associated with displaying the first frame and not displaying the first frame, and wherein said processing is further based upon said error values.

6. The method of claim 5, wherein said error value corresponds to latency values associated with a next frame to be displayed.

7. The method of claim 1, wherein said processing comprises refraining from sending the first frame to the video display and removing the first frame from the buffer when the timestamp associated with the first frame is earlier than the display time.

8. The method of claim 1, wherein said processing comprises sending the first frame to the video display and removing the first frame from the buffer when the timestamp of the first frame exceeds the display time by less than an acceptable latency value.

9. The method of claim 8, wherein the acceptable latency value is 150 ms.

10. A method to process a video stream, comprising:
storing a plurality of frames of a video stream in a buffer, each frame comprising video information and a timestamp;
determining a display frame rate associated with a video display;
determining a future display time value from the display frame rate and a current time; and
processing a first frame of the plurality of frames based upon the future display time value, a timestamp associated with the first frame, and timestamps of additional frames stored in the buffer,
wherein processing comprises sending the first frame to the video display and removing the first frame from the buffer when the timestamp of the first frame exceeds the display time by less than an acceptable latency value.

11. The method of claim 10, wherein the additional frames stored in the buffer comprises all of the frames stored in the buffer except for the first frame.

12. The method of claim 10, further comprising receiving an indication of a number of frames to include as the additional frames stored in the buffer.

13. The method of claim 10, further comprising receiving a latency tolerance value and wherein said processing the first frame of the plurality of frames is further based on the latency tolerance value.

14. The method of claim 10, further comprising determining error values associated with displaying the first frame and not displaying the first frame, and wherein said processing is further based upon said error values.

15. The method of claim 14, wherein said error value corresponds to latency values associated with a next frame to be displayed.

16. A method to process a video stream, comprising:
storing a plurality of frames of a video stream in a buffer, each frame comprising video information and a timestamp;
determining a display frame rate associated with a video display;
determining a future display time value from the display frame rate and a current time;
processing a first frame of the plurality of frames based upon the future display time value, a timestamp associated with the first frame, and timestamps of additional frames stored in the buffer;
wherein said processing comprises refraining from sending the first frame to the video display and removing the first frame from the buffer when the timestamp associated with the first frame is earlier than the display time.

17. The method of claim 16, wherein the additional frames stored in the buffer comprises all of the frames stored in the buffer except for the first frame.

18. The method of claim 16, further comprising receiving an indication of a number of frames to include as the additional frames stored in the buffer.

19. The method of claim 16, further comprising receiving a latency tolerance value and wherein said processing the first frame of the plurality of frames is further based on the latency tolerance value.

20. The method of claim 16, further comprising determining error values associated with displaying the first frame and not displaying the first frame, and wherein said processing is further based upon said error values, wherein said error value corresponds to latency values associated with a next frame to be displayed.
